(19) United States
(12) Patent Application Publication
(10) Pub. No.: US 2014/0236653 A1
(43) Pub. Date: Aug. 21, 2014

(54) SYSTEMS AND METHODS FOR RETAIL LINE MANAGEMENT

(71) Applicant: William M. FARRELL, West Palm Beach, FL (US)

(72) Inventor: William M. FARRELL, West Palm Beach, FL (US)

(73) Assignee: Tyco Fire & Security GmbH, Neuhausen Am Rheinfall (CH)

(21) Appl. No.: 14/180,690

(22) Filed: Feb. 14, 2014

Related U.S. Application Data
(60) Provisional application No. 61/765,474, filed on Feb. 15, 2013.

(51) Int. Cl. G06Q 30/06; G06Q 10/06

(52) U.S. Cl. CPC G06Q 30/0601; G06Q 10/063114
USPC 705/7.15

(57) ABSTRACT

Systems (100) and methods (100) for managing checkout line efficiency of a retail store. The methods involve electronically obtaining, by a store intelligence system (128), first data indicating an efficiency of each checkout lane of a plurality of checkout lanes (152) and second data indicating a total number of shopping carts (106) in each checkout lane and/or a total number of articles within each shopping cart. A checkout lane recommendation is then generated by the store intelligence system for a customer (104) based at least on the first data and/or the second data. The checkout lane recommendation is communicated from the SIS to a mobile communication device (102) in the possession of the customer.

### CROSS REFERENCE TO RELATED APPLICATIONS

This application claims the benefit of U.S. Provisional Patent Application Ser. No. 61/765,474 filed Feb. 15, 2013, which is herein incorporated by reference.

### FIELD OF THE INVENTION

This document relates generally to systems and methods for managing checkout lines in a retail store environment. More particularly, this document relates to systems and methods for optimizing customer checkout processes using network based systems.

### BACKGROUND OF THE INVENTION

Retail customers often become frustrated when attempting to purchase items at a designated Point of Sale (“POS”) system within a retail store environment. When presented with a plurality of POS systems located in different checkout lanes, a customer typically selects a checkout lane based on the probability that the selected lane will provide the fastest checkout. In the face of long lines, a retailer may open additional checkout lanes to alleviate wait times by customer's checking out. But frustration may arise when customers have already waited a long time in a checkout lane and are unlikely to benefit from the opening of the additional checkout lanes. In this regard, it should be understood that customers, who have waited a relatively long amount of time in a checkout lane, often become frustrated when other customers who have waited a relatively short amount of time obtain access to a newly opened checkout lane.

Retailer's often address customer line fairness issues by routing customers into a single file roped-off checkout line for a plurality of POS systems. However, this can be confusing to customers, particularly when there is some uncertainty as to whether there is truly a “single checkout line” system in place. As such, some customers may wait in a single checkout line, while other customers bypass the single checkout line thereby causing frustration by the waiting customers. In order to work efficiently, the “single checkout line” system requires that the store personnel proactively monitor and enforce the single line concept. This is an added burden for store personnel. Also, the “single checkout line” system causes various ingress/egress issues.

In some cases, a rapid checkout experience is provided by designating certain checkout lanes as express checkout lanes. The express checkout lanes can be used by customers who desire to purchase a number of retail items that is less than or equal to a specified allowed number of retail items. This practice often proves to be another source of customer consternation when other customers are observed taking advantage of the express checkout lanes with a number of retail items in excess of the specified allowed number of retail items.

### SUMMARY OF THE INVENTION

The present invention concerns implementing systems and methods for managing checkout line efficiency of a retail store. The methods involve electronically obtaining first data, second data and/or third data by a Store Intelligence System (“SIS”). The first, second and/or third data can be collected by sensors located on or in proximity to shopping carts, checkout lanes and/or point of sales of the retail store. The first data indicates an efficiency of each checkout lane of a plurality of checkout lanes. In some scenarios, the first data specifies at least one of a start time of a checkout process, a number of articles scanned by a point of sale station during the checkout process, a rate of scanning by a cashier, a number of articles that still need to be scanned for a particular customer, and an end time of the checkout process. The second data indicates a total number of shopping carts in each checkout lane and/or a total number of articles within each of the shopping carts. The third data indicates an estimate time at which one or more customers will arrive at a checkout lane (e.g., a duration in which the customer has been in the retail store and/or a number of isles to/from which a respective shopping cart has traveled).

The SIS generates a checkout lane recommendation for the customer based on the first data, the second data and/or the third data. The checkout lane recommendation is then communicated from the SIS to a mobile communication device in the possession of the customer. In some scenarios, the checkout lane recommendation comprises information specifying an estimate time of checkout for at least one of the plurality of checkout lanes. The checkout lane recommendation may be periodically and/or frequently updated based on fourth data. The fourth data may indicate a change in position of at least one shopping cart relative to positions of other shopping carts within a respective checkout lane.

In some scenarios, the methods also involve: detecting when a particular customer is present within a retail store; and communicating information from the SIS to a mobile communication device possessed by a store employee indicating the presence of that customer within the retail store. For example, an image of the customer can be presented to the store employee via his/her mobile communication device. Such information enables the store employee to provide an improved shopping experience for the customer, as will be discussed below. Additionally or alternatively, other information can be communicated from the SIS to the mobile communication device of the customer upon such detection. The other information may specify a welcome greeting, a customer benefit, and/or a promotional material.

While the customer is shopping or waiting to checkout, the SIS can communicate additional information to the mobile communication device of the customer. For example, the customer can be notified of an opening of a new checkout lane, the total number of articles in the respective shopping cart, an eligibility to use an express checkout lane, an eligibility to use a preferred customer checkout lane, and an issue which will likely slow down a checkout time. The customer can be discretely notified of the opening of a new checkout lane if the SIS detects that the customer has been waiting longer than other customers to checkout.

### DESCRIPTION OF THE DRAWINGS

Embodiments will be described with reference to the following drawing figures, in which like numerals represent like items throughout the figures, and in which:

FIG. 1 is a schematic illustration of an exemplary checkout line management system that is useful for understanding the present invention.

FIG. 2 is a schematic illustration of an exemplary checkout area of the retail store facility shown in FIG. 1.

FIG. 3 is a block diagram of an exemplary architecture for a mobile communications device shown in FIG. 1.

FIG. 4 is a block diagram of an exemplary architecture for the smart cart device coupled to a shopping cart as shown in FIG. 1.

FIGS. 5A-5D collectively provide an exemplary method for managing checkout line efficiency that is useful for understanding the present invention.

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

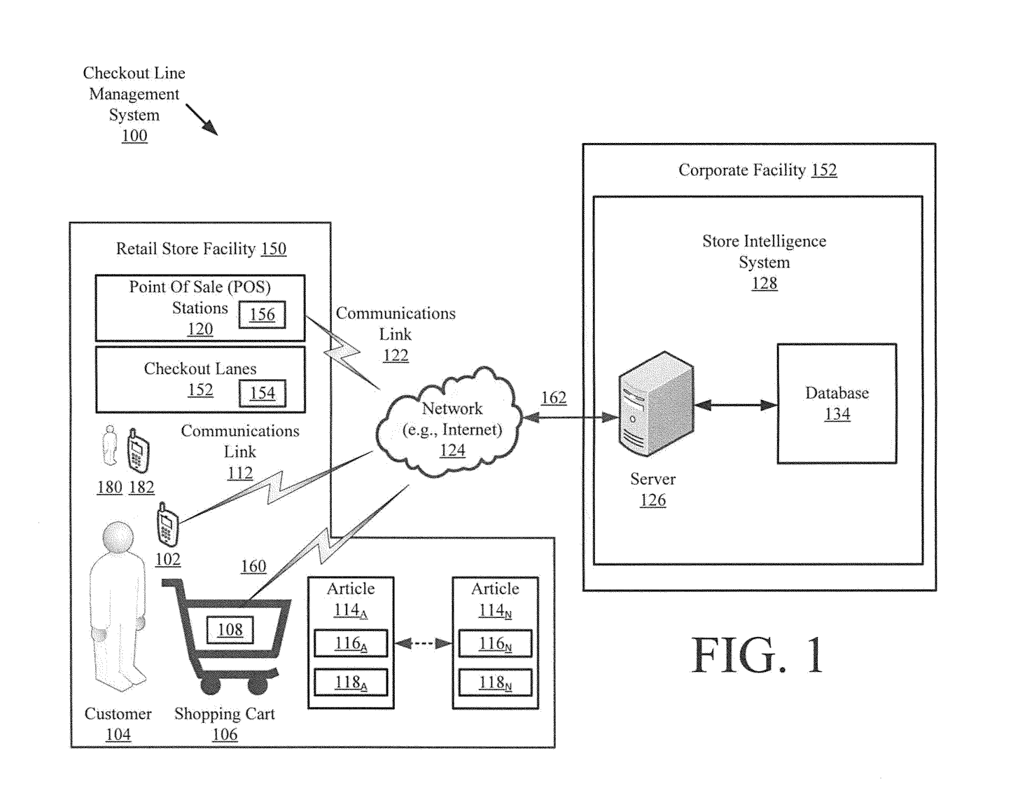

Embodiments will now be described with respect to FIGS. 1-5D. Embodiments generally relate to novel systems and methods for managing checkout line efficiency. The methods involve electronically obtaining first data, second data and/or third data by an SIS. The first, second and/or third data can be collected by sensors located on or in proximity to shopping carts, checkout lanes and/or point of sales of the retail store. The first data indicates an efficiency of each checkout lane of a plurality of checkout lanes. The second data indicates a total number of shopping carts in each checkout lane and/or a total number of articles within each of the shopping carts. The third data indicates an estimate time at which one or more customers will arrive at a checkout lane. The SIS generates a checkout lane recommendation for the customer based on the first data, the second data and/or the third data. The checkout lane recommendation is then communicated from the SIS to a mobile communication device in the possession of the customer. In some scenarios, the checkout lane recommendation comprises information specifying an estimate time of checkout for at least one of the plurality of checkout lanes. The checkout lane recommendation may be periodically and/or frequently updated based on newly acquired data.

In some scenarios, the methods also involve: detecting when a particular customer is present within a retail store; and communicating information from the SIS to a mobile communication device possessed by a store employee indicating the presence of that customer within the retail store. For example, an image of the customer can be presented to the store employee via his/her mobile communication device. Such information enables the store employee to provide an improved shopping experience for the customer, as will discussed below. Additionally or alternatively, other information can be communicated from the SIS to the mobile communication device of the customer upon such detection. The other information may specify a welcome greeting, a customer benefit, and/or a promotional material.

While the customer is shopping or waiting to checkout, the SIS can communicate additional information to the mobile communication device of the customer. For example, the customer can be notified of an opening of a new checkout lane, the total number of articles in the respective shopping cart, an eligibility to use an express checkout lane, an eligibility to use a preferred customer checkout lane, and an issue which will likely slow down a checkout time. The customer can be discretely notified of the opening of a new checkout lane if the SIS detects that the customer has been waiting longer than other customers to checkout.

Notably, the present invention provides certain benefits to retail stores. In this regard, it should be understood that the present invention addresses at least three customer complaints: (1) customers who have waited a relatively long time in a checkout lane are unlikely to benefit from the opening of the additional checkout lanes; (2) customers who have more than the allowed number of items often use express lanes; and (3) the customer service to preferred or elite customers is not satisfactory. Customer complaint (1) is addressed by the present invention since customers can be selectively and personally alerted that a new checkout lane is about to be opened or has just been opened. Customer complaint (2) is addressed by the present invention since customers with articles exceeding the maximum number of allowed articles in an express lane can be discretely notified on their MCD to move to a non-express checkout lane. Customer complaint (3) is addressed by the present invention since (a) wireless notification of priority checkout lanes is provided to the preferred or elite customers via their MCDs and/or (b) store employees are provided with information identifying preferred or elite customers present within the retail store.

The present invention also allows the performance of store personnel operating the POS stations to be monitored in real time for efficiency. As a result, training issues can be identified earlier than before. The data collected and stored by the SIS may be used to calculate the efficiency of checkout of the cashiers. For example, the slower performance of a particular cashier may signal a training issue which can be quickly corrected if identified by a performance evaluation feature of the SIS. The present invention enables real-time cloud-based cashier efficiency ratings to be calculated. Once a rate of scanning is established for a particular cashier, this data can also be used by the SIS to more accurately estimate a checkout time. A more accurate measurement of future cashier staffing demands can be made utilizing the cashier effiency ratings.

The SIS of the present invention optimizes the efficiency of the customer checkout process by providing a checkout optimization feature. A database representing real-time status and availability of checkout lanes is maintained. Additionally, the performance of the checkout process is monitored. One of the metrics monitored may include monitoring the time it takes for each cashier to scan the items and tender the transaction. The length of the transaction can be defined as the time lapsed from the first item scanned to payment tendered.

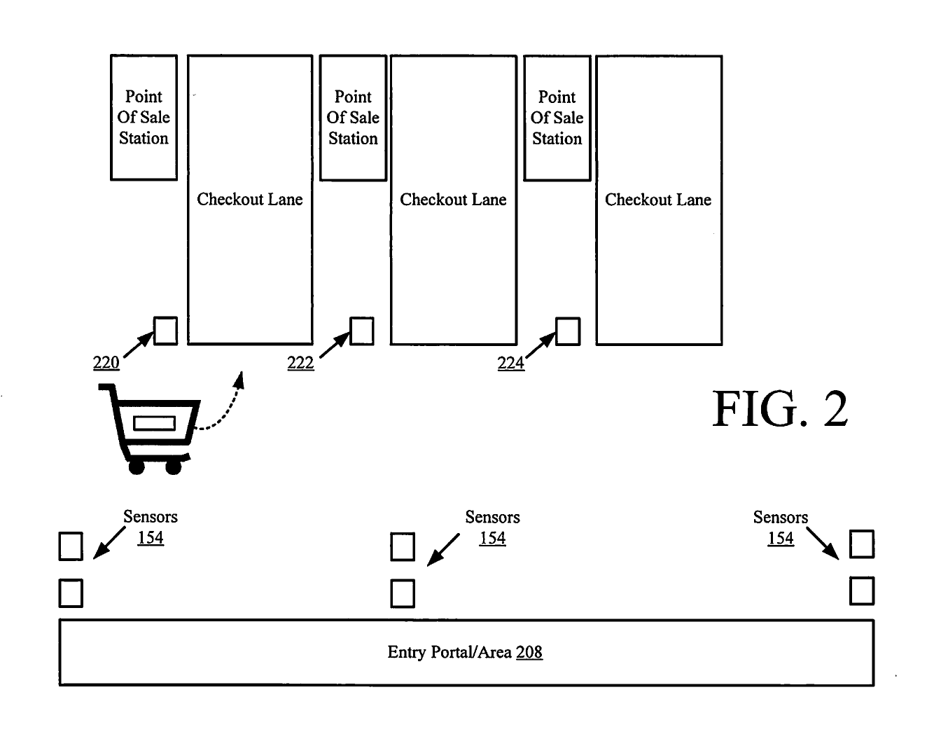

Referring now to FIGS. 1-2, there is provided a schematic illustration of an exemplary Checkout Line Management (“CLM”) system 100 that is useful for understanding the present invention. The CLM system 100 is shown as comprising a distributed computing environment (e.g., a cloud computing environment) utilizing several computer systems and components that are interconnected via various communication links, using one or more computer networks or direct connections. However, it will be appreciated by those of ordinary skill in the art that such a system could operate equally well in a system having fewer or a greater number of components than that illustrated in FIG. 1. Thus, the depiction of system 100 in FIG. 1 should be taken as being illustrative in nature and not limiting in scope of the disclosure.

The CLM system 100 comprises a retail store facility 150 in which customers 104 can purchase articles 114_{A}, . . . , 114_{N} offered for sale by the retail store. Accordingly, the retail store facility 150 comprises a plurality of checkout lanes 152. Each checkout lane 152 is associated with a respective one of a plurality of POS stations 120. POS stations are well known in the art, and therefore will not be described herein. Still, it should be understood that each POS station 120 can be an employee operated POS station or a self-service kiosk.

Notably, the CLM system 100 is generally configured to provide customers 104 of the retail store with improved customer service. In this regard, each POS station 120 is configured to communicate with a Store Intelligence System (“SIS”) 128 via a communication link 122 and a network 124 (e.g., the Internet, an Intranet, a cellular network, a local area network, and/or other type of network). In some scenarios, the POS station 120 comprises sensors 156 for periodically or continuously collecting data indicative of the efficiency of the respective checkout lane 152. This information is then provided to the SIS 128. Such data can include, but is not limited to, data useful for determining a relative speed and/or an estimate duration of checkout for a particular customer purchasing a certain number of articles (e.g., the time a checkout process began, the number of articles already scanned by a POS scanner, the rate of scanning, the number of articles that still need to be scanned for that particular customer, and the time that the checkout process is completed).

Also, the checkout lanes 152 have sensors 154 located thereat. The sensors 154 are provided to detect: the presence of shopping carts 106 in their respective checkout lanes 152; and/or the number of items being placed on a conveyer at any given time. Data indicating such detection may be provided directly to the SIS 128 via the sensors 154 or indirectly to the SIS 128 via the POS station 120. The SIS 128 can use this data to track the number of shopping carts present in each checkout lane and the number of articles that are being purchased for each customer in each checkout lane.

The sensors 152, 154 can include, but are not limited to, photoelectric sensors (or beam break sensors) and/or Short Range Communication (“SRC”) devices (e.g., barcode readers, RFID readers or near field communication devices). SRC devices are well known in the art, and therefore will not be discussed in detail herein. Still, it should be understood that in the SRC scenarios the articles 114_{A}, . . . , 114_{N} have barcodes 116_{A}, . . . , 116_{N} affixed thereto and/or SRC devices 118_{A}, . . . , 118_{N} coupled thereto from which the SRC devices can obtain product information and/or by which the presence of the articles can be detected.

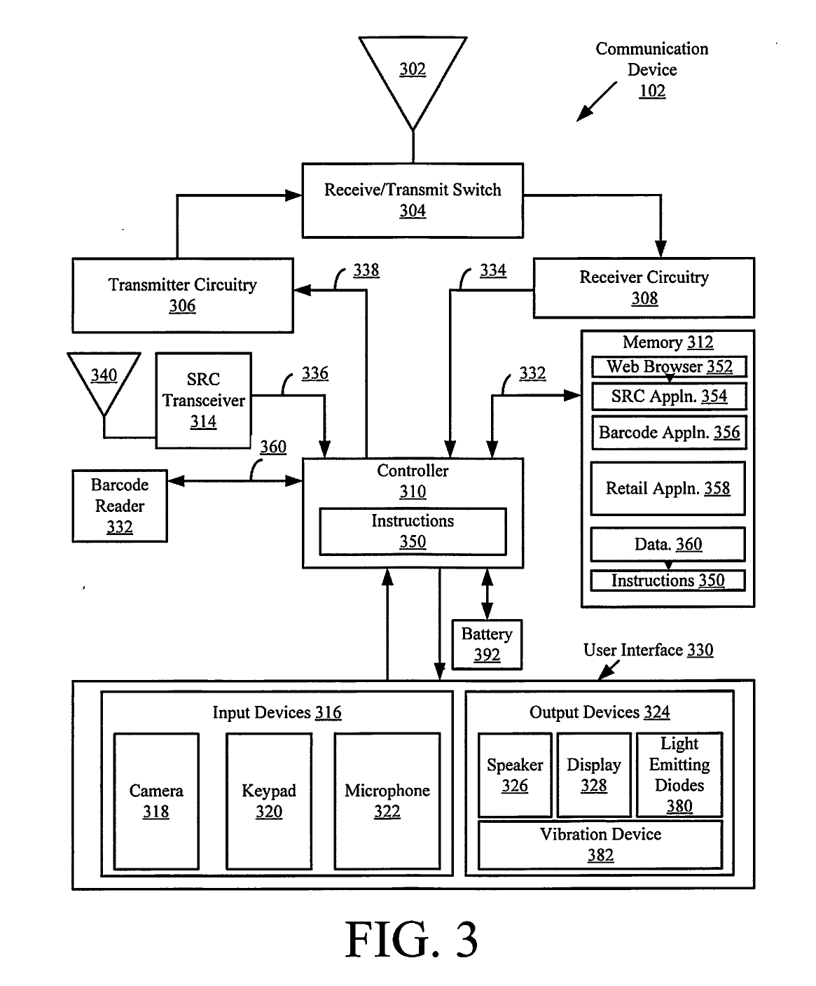

The improved customer service can include providing the customers 104 with optimized checkout suggestions via a network based service accessible through their Mobile Communication Devices (“MCDs”) 102. An exemplary architecture for the mobile communication devices 102 will be described below in relation to FIG. 3. However, it should be understood that the MCDs can include, but are not limited to, personal computers, cell phones, handheld messaging devices, laptop computers, set-top boxes, personal data assistants, and/or electronic book readers. Each MCD can have a retail application running thereon for facilitating communications with a Smart Cart (“SC”) device 108 and the SIS 128. The retail application can be downloaded to the MCDs from the SIS 128, and launched automatically or manually when a respective customer 104 enters the retail store facility 150. Upon being launched, the customer 104 logs into the SIS 128. Thereafter, the retail application communicates data to and from the external devices 108, 128 for purposes of providing the customer 104 with various information regarding customer benefits (e.g., which articles are on sale), the efficiency of the checkout process associated with each checkout lane 152, and/or authorization to use a particular checkout lane accessible only to preferred customers. Upon exiting the retail store facility 150, the retail application can be automatically or manually closed.

While the customer 104 is shopping, system 100 performs various operations to manage checkout line efficiency. In this regard, various components of system 100 collect data useful for such checkout line management. For example, an SC device 108 is coupled to each shopping cart 106 of the retail store facility 150. The SC device 108 is generally configured to facilitate checkout line management. An exemplary architecture of the SC device 108 will be described below in relation to FIG. 3. Still, it should be understood that the SC device 108 comprises sensors operative to collect data concerning articles 114_{A}, . . . , 114_{N} offered for sale in the retail store facility 150, as well as data concerning shopping carts. More specifically, the SC device 108 detects: the number and/or type of articles placed in a respective shopping cart 106; and/or the location of the shopping cart 106 within the retail store facility 150 (e.g., tracks to/from which isles a shopping cart has traveled). Thereafter, the collected data is communicated from the SC device 108 to the SIS 128, along with a unique identifier associated with the shopping cart 106. In some scenarios, this communication is enabled via communication links 160, 162 and a network 124. The communication can be performed continuously in real time or triggered by the arrival of shopping cart 106 at a particular location within the retail store facility 150 (e.g., at an entry point of a checkout lane 152).

At the SIS 128, the received data is stored in a database 134 and used to evaluate the efficiency of one or more checkout lanes 152 of the retail store facility 150. This evaluation generally involves using an algorithm to determine which checkout lane will likely proceed more rapidly relative to the other checkout lanes 152 and/or the estimated time of checkout for that checkout lane and/or customer 104. The results of this determination may be provided to the customer 104 via the retail application and/or a text messaging application running on his/her MCD 104. The SIS 128 may also communicate other information to the MCD 104. The other information can include, but is not limited to, information specifying a welcoming greeting, customer benefits, new checkout lane openings, a total number of articles in a respective shopping cart, an eligibility to use an express checkout lane, and/or issues which will slow checkout times (e.g., article price disputes between another customer and a store employee).

For the benefit of customers who may not be carrying an MCD, the SIS 128 may perform actions to provide a public advisement of checkout lane availability. For example, the SIS 128 instructs the POS stations 120 and/or other electronic devices to cause an output of a visual announcement and/or an audio announcement from output devices (e.g., output device 220, 222, 224 of FIG. 2) located near the checkout lanes 152 announcing which checkout lanes will likely proceed more rapidly relative to the other checkout lanes and/or the estimated times of checkout for the checkout lanes 152.

In some scenarios, a visual cue is presented in the form of a traffic light indicator mounted at the end of each checkout lane conveyer belt. For a checkout lane estimated to have the fastest checkout time, a green indicator light can be emitted from a output device (e.g., output device 220, 222, or 224 of FIG. 2). A yellow indicator light may be emitted from the output device when the checkout lane is estimated to have an average checkout time. As a customer pushes his/her cart into the area of the checkout lanes (e.g., entry portal/area 208 of FIG. 2) and a first sensor is encountered, data indicating the final shopping cart contents may be communicated from the SC device 108 to the SIS 128. At the SIS 128, the data is processed to determine whether the traffic light indicators should be updated. If so, then the SIS 128 performs operations to cause the traffic light indicators to be updated, thereby providing customers with visual cues as to which checkout lane is the optimal choice for their best checkout experience.

The SIS 128 is shown in FIG. 1 as being located in a corporate facility 152. Embodiments of the present invention are not limited in this regard. The SIS 128 can alternatively or at least partially be disposed within the retail store facility 150. In all scenarios, the SIS 128 includes at least a server 126 and a database 134.

Referring now to FIG. 3, there is provided a block diagram of an exemplary architecture for MCD 102 that is useful for understanding the present invention. MCD 102 may include more or less components than those shown in FIG. 3. However, the components shown are sufficient to disclose an illustrative embodiment implementing the present invention. Some or all of the components of the MCD 102 can be implemented in hardware, software and/or a combination of hardware and software. The hardware includes, but is not limited to, one or more electronic circuits.

As noted above, MCD 102 can include, but is not limited to, a notebook computer, a personal digital assistant, a cellular phone or a mobile phone with smart device functionality (e.g., a Smartphone). In this regard, the MCD 102 comprises an antenna 302 for receiving and transmitting Radio Frequency (“RF”) signals. A receive/transmit (“Rx/Tx”) switch 304 selectively couples the antenna 302 to the transmitter circuitry 306 and the receiver circuitry 308 in a manner familiar to those skilled in the art. The receiver circuitry 308 demodulates and decodes the RF signals received from an external device. The receiver circuitry 308 is coupled to a controller (or microprocessor) 310 via an electrical connection 334. The receiver circuitry 308 provides the decoded signal information to the controller 310. The controller 310 uses the decoded RF signal information in accordance with the function(s) of the MCD 102. The controller 310 also provides information to the transmitter circuitry 306 for encoding and modulating information into RF signals. Accordingly, the controller 210 is coupled to the transmitter circuitry 306 via an electrical connection 338. The transmitter circuitry 306 communicates the RF signals to the antenna 302 for transmission to an external device via the Rx/Tx switch 304.

MCD 102 is also comprises an antenna 340 coupled to an SRC transceiver 314 for receiving SRC signals. SRC transceivers are well known in the art, and therefore will not be described in detail herein. However, it should be understood that the SRC transceiver 314 processes the SRC signals to extract information therefrom. The SRC transceiver 314 may process the SRC signals in a manner defined by the SRC application 354 installed on the MCD 102. The SRC application 354 can include, but is not limited to, a Commercial Off the Shelf (“COTS”) application. The SRC transceiver 314 is coupled to the controller 310 via an electrical connection 336. The controller uses the extracted information in accordance with the function(s) of the MCD 102. For example, the extracted information can be used by the MCD 102 to determine that it is in proximity of a checkout lane or other area of a retail store in which a customer can take advantage of a certain benefit offered thereto (e.g., a product which is on sale). In this regard, the SRC signals can be received from SRC devices coupled to articles for sale, shelving on which the articles are placed, or a kiosk in proximity to the articles and/or isle in which the articles can be found.

The controller 310 may store received and extracted information in memory 312 of the MCD 102. Accordingly, the memory 312 is connected to and accessible by the controller 310 through electrical connection 332. The memory 312 may be a volatile memory and/or a non-volatile memory. For example, memory 312 can include, but is not limited to, a RAM, a DRAM, a ROM and a flash memory. The memory 312 may also comprise unsecure memory and/or secure memory. The memory 312 can be used to store various other types of data 360 therein, such as authentication information, cryptographic information, location information, and various article-related information.

The MCD 102 also may comprise a barcode reader 332. Barcode readers are well known in the art, and therefore will not be described herein. However, it should be understood that the barcode reader 332 is generally configured to scan a barcode and process the scanned barcode to extract information therefrom. The barcode reader 332 may process the barcode in a manner defined by the barcode application 356 installed on the MCD 102. Additionally, the barcode scanning application can use camera 318 to capture the barcode image for processing. The barcode application 356 can include, but is not limited to, a COTS application. The barcode reader 332 provides the extracted information to the controller 310. As such, the barcode reader 332 is coupled to the controller 310 via an electrical connection 360. The controller 310 uses the extracted information in accordance with the function(s) of the MCD 102. For example, the extracted information can be used by MCD 102 to obtain price and/or product information for a particular article.

As shown in FIG. 3, one or more sets of instructions 350 are stored in memory 312. The instructions may include customizable instructions and non-customizable instructions. The instructions 350 can also reside, completely or at least partially, within the controller 310 during execution thereof by MCD 102. In this regard, the memory 312 and the controller 310 can constitute machine-readable media. The term “machine-readable media”, as used herein, refers to a single medium or multiple media that stores one or more sets of instructions 350. The term “machine-readable media”, as used here, also refers to any medium that is capable of storing, encoding or carrying the set of instructions 350 for execution by the MCD 102 and that causes the MCD 102 to perform one or more of the methodologies of the present disclosure.

The controller 310 is also connected to a user interface 330. The user interface 330 comprises input devices 316, output devices 324 and software routines (not shown in FIG. 3) configured to allow a user to interact with and control software applications (e.g., software applications 352-258 and other software applications) installed on MCD 102. Such input and output devices may include, but are not limited to, a display 328, a speaker 326, a keypad 320, a directional pad (not shown in FIG. 3), a directional knob (not shown in FIG. 3), a microphone 322, and a cameral 318. The display 328 may be designed to accept touch screen inputs. As such, user interface 330 can facilitate a user software interaction for launching applications (e.g., software applications 352-258 and other software applications) installed on MCD 102. The user interface 330 can facilitate a user-software interactive session for: initiating communications with an external device; writing data to and reading data from memory 312; initiating a retail application process for providing a user with improved customer service. The retail application process will be described below in detail.

The display 328, keypad 320, directional pad (not shown in FIG. 3) and directional knob (not shown in FIG. 3) can collectively provide a user with a means to initiate one or more software applications or functions of MCD 102. The application software 352-358 can facilitate the data exchange (a) a user and the MCD 102, (b) the MCD 102 and a POS station (e.g., POS station 120 of FIG. 1), and/or (c) the MCD 102 and an SC device (e.g., SC device 108 of FIG. 1) coupled to a shopping cart (e.g., chopping cart 106 of FIG. 1). In this regard, the application software 352-358 performs one or more of the following: verify the identity of a user of MCD 102 via an authentication process; present information to the user indicating this his/her identity has or has not been verified; present a Graphical User Interface (“GUI”) to the user for enabling the user to initiate a customer service process for providing the user with improved customer service when the user is in a retail store facility (e.g., retail store facility 150 of FIG. 1).

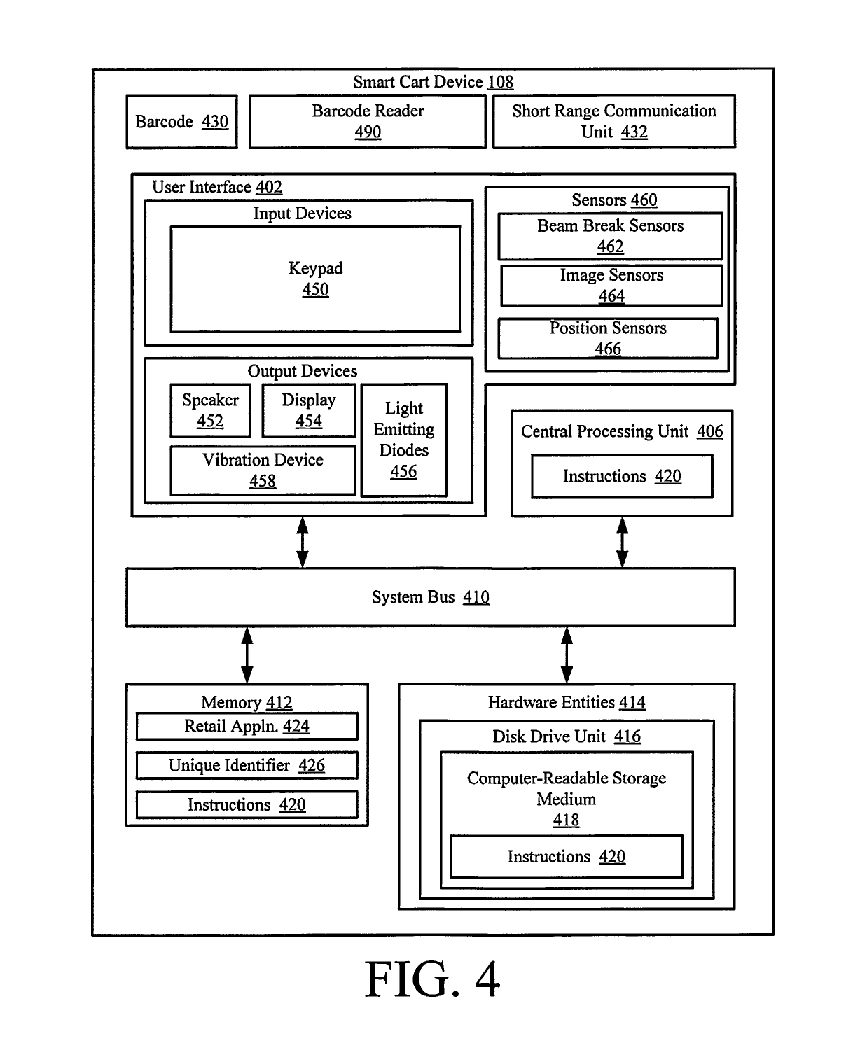

Referring now to FIG. 4, there is provided a block diagram of an exemplary architecture for the SC device 108 of FIG. 1. The server 126 of FIG. 1 has an architecture that is the same as or similar to that of SC device 108. As such, the following discussion of SC device 108 is sufficient for understanding server 126. In some scenarios, server 126 is absent of components 430, 432, 458, 460 and/or 490 of SC device 108, but comprises the remaining components thereof.

Notably, the SC device 108 may include more or less components than those shown in FIG. 4. However, the components shown are sufficient to disclose an illustrative embodiment implementing the present invention. The hardware architecture of FIG. 4 represents one embodiment of a representative SC device configured to facilitate the provision of improved customer service to a customer of a retail store. As such, the SC device 108 of FIG. 4 implements at least a portion of a method for providing such improved customer service in accordance with embodiments of the present invention. Some or all the components of the SC device 108 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 4, the SC device 108 comprises a user interface 402, a Central Processing Unit (“CPU”) 406, a system bus 410, a memory 412 connected to and accessible by other portions of SC device 108 through system bus 410, and hardware entities 414 connected to system bus 410. The user interface can include input devices (e.g., a keypad 450) and output devices (e.g., speaker 452, a display 454, a vibration device 458 and/or light emitting diodes 456), which facilitate user-software interactions for controlling operations of the SC device 108.

At least some of the hardware entities 414 perform actions involving access to and use of memory 412, which can be a Random Access Memory (“RAM”), a disk driver and/or a Compact Disc Read Only Memory (“CD-ROM”). The SC device 108 also comprises sensors 460, a barcode 430, a barcode reader 490 and an SRC unit 432. The sensors 460 can include, but are not limited to, beam break sensors 462, image sensors 464, and position sensors 466. The position sensors may comprise Global Positioning System (“GPS”) based location detection devices, triangulation based location detection device, and/or any other location detection device known or to be known which is suitable for a particular application.

Components 432, 460 and/or 490 are operative to generally collect data concerning articles (e.g., article 114_{A}, . . . , 114_{N} of FIG. 1) offered for sale in the retail store facility (e.g., retail store facility 150 of FIG. 1) as well as data concerning shopping carts (e.g., shopping cart 106 of FIG. 1). More specifically, the components 432, 460 and/or 490 detect: the number and/or type of articles placed in a respective shopping cart; and/or the location of the shopping cart within the retail store facility (e.g., tracks to/from which isles a shopping cart has traveled).

Hardware entities 414 can include a disk drive unit 416 comprising a computer-readable storage medium 418 on which is stored one or more sets of instructions 420 (e.g., software code) configured to implement one or more of the methodologies, procedures, or functions described herein. The instructions 420 can also reside, completely or at least partially, within the memory 412 and/or within the CPU 406 during execution thereof by the SC device 108. The memory 412 and the CPU 406 also can constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 420 for execution by the SC device 108 and that cause the SC device 108 to perform any one or more of the methodologies of the present disclosure.

In some embodiments of the present invention, the hardware entities 414 include an electronic circuit (e.g., a processor) programmed for facilitating the provision of improved customer service to a customer of a retail store. In this regard, it should be understood that the electronic circuit can access and run a retail software application 424 installed on the SC device 108. The retail software application 424 is generally operative to facilitate the management of checkout line efficiency by causing data collected by sensors 460 to be stored in memory 412 and/or communicated to an external device (e.g., MCD 102 of FIG. 1 and/or SIS 128 of FIG. 1) along with a unique identifier 426 associated with the respective shopping cart via network connection. The collected data can also be processed by the SC device and/or the external device to evaluate the efficiency of one or more checkout lanes 152 of the retail store facility 150. This evaluation generally involves using an algorithm to determine which checkout lane will likely proceed more rapidly relative to the other checkout lanes and/or the estimated time of checkout for that checkout lane and/or customer. The results of this determination may be provided to the customer via his/her MCD (e.g., MCD 104 of FIG. 1). Other functions of the retail software application 424 will become apparent as the discussion progresses.

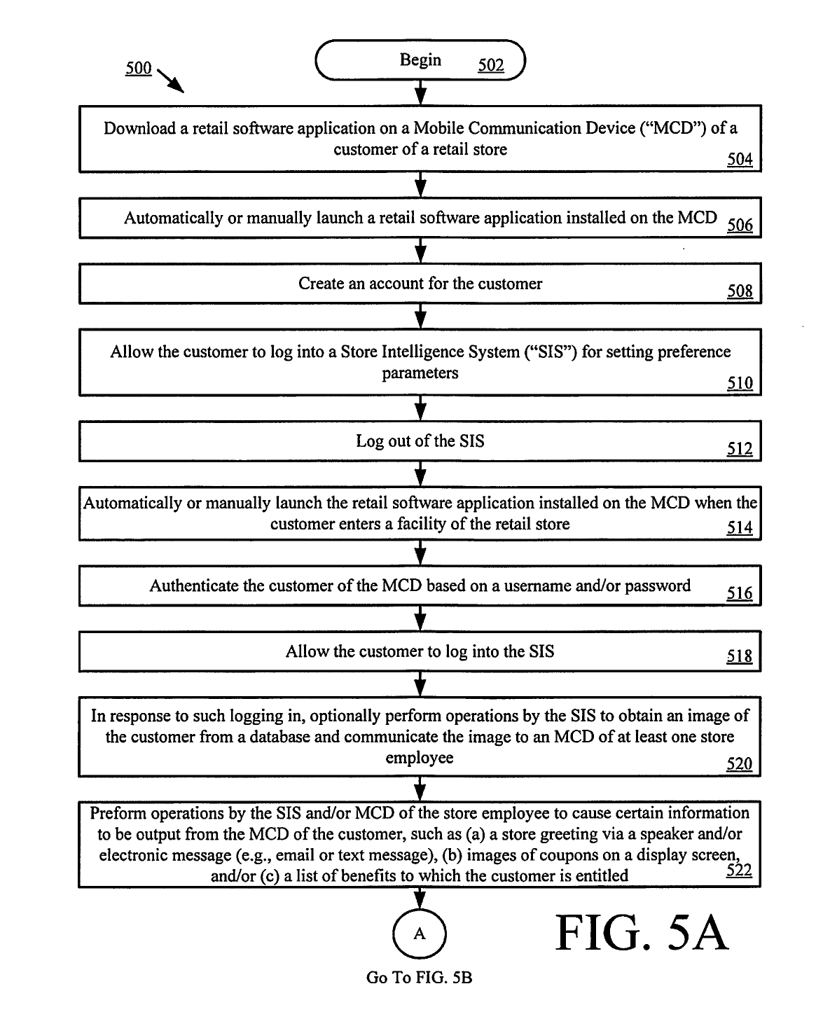

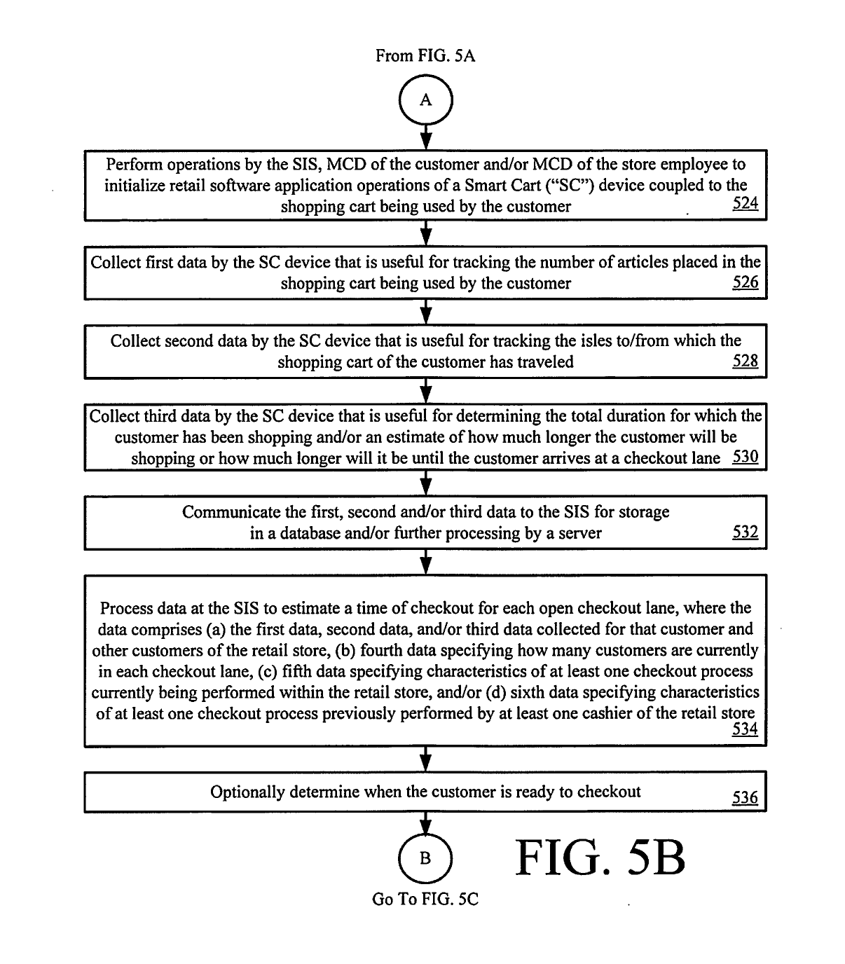

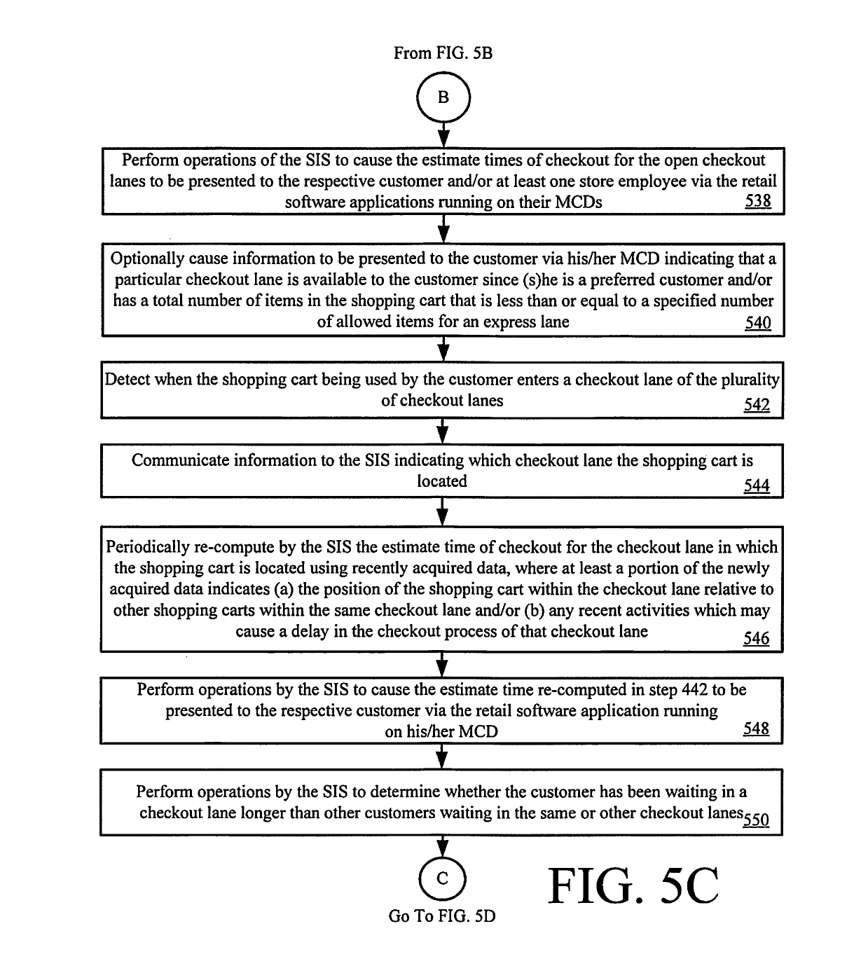

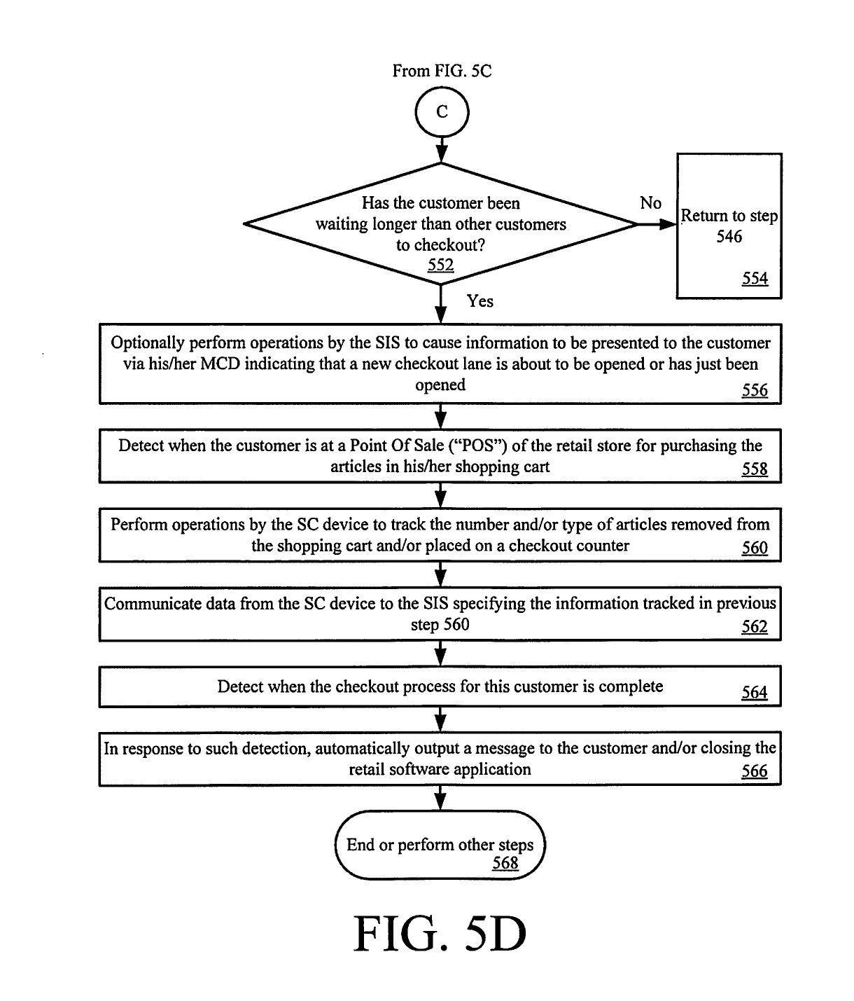

Referring now to FIGS. 5A-5D, there is provided a flow diagram of an exemplary method 500 for managing checkout line efficiency. Method 500 begins with step 502 and continues with step 504. In step 504, a retail software application (e.g., retail software application 358 of FIG. 3) is downloaded to an MCD (e.g., MCD 102 of FIG. 1) of a customer (e.g., customer 104 of FIG. 1) of a retail store. The download can be achieved via a public network (e.g., network 124 of FIG. 1) communicatively coupling the MCD to an SIS (e.g., SIS 128 of FIG. 1). Next in step 506, the retail software application is automatically launched or manually launched. Thereafter, the customer creates an account using one or more GUIs of the retail software application. In this regard, the customer may specify a user name and a password for use in a subsequent authentication thereof. Once the account has been created, step 510 is performed where the customer logs into the SIS to set values for a plurality of preference parameters. Upon setting the preference parameter values, the customer can log out of the SIS, as shown by step 512.

Notably, the retail software application can be used by the customer during a shopping spree at the retail store so as to obtain improved customer service. As such, the retail software application is automatically or manually launched when the customer enters a facility of the retail store (e.g., retail store facility 152 of FIG. 1), as shown by step 514. In some scenarios, the automatic launching of the retail software application can be triggered upon detection of the presence of the MCD within an entry point of the retail store. Such detection can be made by one or more sensors located at the entry point of the retail store which are communicatively coupled to the SIS. The sensors may obtain a unique identifier of the MCD and forward the unique identifier to the SIS. At the SIS, the unique identifier is compared to a list of unique identifiers for MCDs associated with customer accounts. If the unique identifier matches a unique identifier on the list, then the SIS can perform operations to cause the retail software application installed on the MCD to be automatically launched.

In a next step 516, the customer is authenticated by the SIS using the username and/or password specified by the customer when creating the customer account. Once the customer has been authenticated, the customer is allowed to log into the SIS, as shown by step 518. In response to such logging in, the SIS optionally performs operations to obtain an image of the customer from a database (e.g., database 134 of FIG. 1) and communicate the image to an MCD (e.g., MCD 182 of FIG. 1) of at least one store employee (e.g., store employee 180 of FIG. 1), as shown by step 520. Notably, the image may be provided to the store employee such that the store employee is notified as to the entering of a preferred customer into the retail store. In response to such notification, the store employee may personally greet the customer and inquire as to how the store employee may assist the customer so as to improve his/her shopping experience. The present invention is not limited to the provision of a customer image here. Additionally or alternatively, other information may be communicated from the SIS to the MCD possessed by the store employee indicating the presence of the customer within the retail store, such as a text message or electronic mail message with a textual notification. Also, visual or tactile notifications can also be provided to the store employee via his/her MCD.

In step 522, various operations can be performed to cause certain information to be presented to the customer of the MCD. These operations can be performed by the SIS and/or the MCD of the store employee. The information can include, but is not limited to, a store greeting, sale particularities, customer benefits and/or promotional materials. The store greeting can be output from the MCD via a speaker (e.g., speaker 326 of FIG. 3) and/or a display screen (e.g., display screen 328 of FIG. 3) as an electronic message (e.g., a text message or an electronic mail message). The sale particularities can be output from the MCD as coupon images displayed on the display screen. The customer benefits can be displayed on the display screen as a list of benefits to which the customer is entitled (e.g., sales only offered to preferred customers, a personalized shopping employee, and/or access to a preferred customer checkout line). The promotional materials may be contained in an electronic message (e.g., a text message or an electronic mail message). Upon completing step 522, method 500 continues with step 524 of FIG. 5B.

As shown in FIG. 5B, step 524 involves performing operations to initialize retail software application operations of an SC device (e.g., SC device 108 of FIGS. 1 and 4) coupled to the shopping cart being used by the customer. The operations can be performed by the SIS, the MCD of the customer, and/or the MCD of the store employee. For example, if the SIS may transmit a signal to the SIS device directly or indirectly via an intermediary device to cause the retail software application operations to be initialized. Similarly, if one of the MCDs is used for this purpose, then the MCD can detect when it is in proximity to an SC device, and thereafter communicate a signal to the SC device via an SRC (e.g., a near field communication).

Subsequent to the initialization of the retail software application operations, the SC device collects first data, second data and/or third data as shown by steps 526, 528 and 530. The first data comprises information that is useful for tracking the number of articles placed in the shopping cart being used by the customer. The second data comprises information that is useful for tracking the isles to/from which the shopping cart of the customer has traveled and/or determining an estimate time at which the customer will arrive at a checkout lane. The third data comprises information that is useful for (a) determining the total duration for which the customer has been shopping and/or (b) an estimate of how much longer the customer will be shopping or how much longer will it be until the customer arrives at a checkout lane. The first, second and/or third data is then communicated from the SC device to the SIS for storage in a database (e.g., database 134 of FIG. 1) and/or further processing by a server (e.g., server 126 of FIG. 1), as shown by step 532.

At the SIS, various data is processed to estimate a time of checkout for each open checkout lane (e.g., checkout lanes 152 of FIG. 1). The data can include, but is not limited to, the following: (a) the first, second and third data collected for that customer and other customers in the retail store; (b) fourth data specifying how many customers are currently in each checkout lane; (c) fifth data specifying characteristics of at least one checkout process current being performed within the retail store; and/or (d) sixth data specifying characteristics of at least one checkout process previously performed by at least one cashier of the retail store. The fourth data can be obtained from sensors (e.g., sensors 154 of FIGS. 1 and 2) located at the checkout lanes. The fifth data can be obtained from sensors (e.g., sensors 156 of FIG. 1) of the POS station(s) (e.g., POS station(s) 120 of FIG. 1). The fifth data can include, but is not limited to, data useful for determining a relative speed and/or an estimate duration of checkout for a particular customer purchasing a certain number of articles (e.g., the time a checkout process began, the number of articles already scanned by a POS scanner, the rate of scanning, the number of articles that still need to be scanned for that particular customer, and the time that the checkout process is completed). The sixth data can be obtained from historical data stored in a database (e.g., database 134 of FIG. 1) of the SIS.

In a next optional step 536, a determination is made as to when the customer is ready to checkout. This determination can be made by the SIS using the second data collected in previous step 528 and third data collected in step 530. Subsequently, method 500 continues with step 538 of FIG. 5C.

As shown in FIG. 5C, step 538 involves performing operations by the SIS to cause the estimate times of checkout for the open checkout lanes to be presented to the customer via the retail software application running on his/her MCD and/or to at least one store employee via the retail software application running on his/her MCD. In some customer scenarios, step 538 is performed in response to a determination in previous optional step 536 that the customer is ready to checkout. In other customer scenarios, step 538 is performed in response to a user-software interaction by the customer using his/her MCD, which causes a request to be communicated from the MCD to the SIS for obtaining checkout lane recommendations. In all store employee scenarios, step 538 can be performed automatically on a periodic basis or in response to a user-software interaction by the store employee requesting access to such information.

The estimate times of checkout can be presented to the customer in any format within a GUI of the retail software application and/or within an electronic message (e.g., text message or electronic mail message). For example, the estimate times of checkout can be presented in a table format, a graph format, or a map format with or without color coding. In step 540, the SIS can also perform operations to cause additional information to be presented to the customer via his/her MCD. This additional information can indicate that: a particular checkout lane is available to the customer since (s)he is a preferred customer; an express lane is available to the customer since (s)he has a total number of items in the shopping cart that is less than or equal to a specified number of allowed items for an express lane; and/or that the express lanes are not available to the customer since (s)he has a total number of items in the shipping cart that exceeds the specified number of allowed items for the express lanes.

Thereafter, step 542 is performed in which a detection is made as to when the shopping cart enters a checkout lane of the plurality of checkout lanes. This detection can be made by sensors (e.g., sensors 154 of FIGS. 1-2) located adjacent to or in proximity to the checkout lane. In response to such detection, information is communicated from the sensors to the SIS indicating which checkout lane the shopping cart is located, as shown by step 544. This communication can be a direct communication between the sensors and SIS, or alternatively an indirect communication via an intermediary device such as the MCD of the customer, the MCD of the store employee or the POS station associated with that checkout lane.

Notably, the SIS periodically re-computes the estimate times of checkout for the checkout lanes using recently or newly acquired data that is relevant to such computations, as shown by step 546. The periodic re-computing can be performed frequently such that it appears to be performed in real-time. The newly acquired data may indicate: (a) the position of the shopping cart within the checkout lane relative to other shopping carts within the same checkout lane; and/or (b) any recent activities which may cause a delay in the checkout process of that checkout lane. Such activities may include, but are not limited to, the following: price disputes; unmarked articles; coupons which require scrutiny and/or verification; article defects; payment issues (e.g., a customer is unable to pay for one or more articles and/or a payment type requires scrutiny and/or verification); and/or malfunctions of the POS station.

The re-computed estimate times of checkout are then communicated from the SIS to the MCD of the customer, as shown by step 548. The re-computed estimate times of checkout are thereafter presented to the customer via the retail software application running on his/her MCD. In some scenarios, the re-computed estimate times of checkout can be presented to the customer in the form of a decrementing countdown timer showing estimated time remaining until checkout may commence. Other information may also be presented to the customer at this time. Such other information can include, but is not limited to, information indicating a rate of throughput for at least the cashier associated with the respective checkout lane.

In some scenarios, step 550 is performed in which the SIS determines whether the customer has been waiting in a checkout lane longer than other customers waiting in the same or other checkout lanes. If the customer has not been waiting longer than other customers to checkout [552:NO], then method 500 returns to step 546 of FIG. 5C, as shown by step 554 of FIG. 5D. If the customer has been waiting longer than other customers to checkout [552:YES], then method 500 continues with optional step 556 of FIG. 5D. Optional step 556 involves performing operations by the SIS to cause information to be presented to the customer via his/her MCD indicating that a new checkout lane is about to be opened or has just been opened.

Subsequently in step 558, a detection is made as to when the customer is at a POS station of the retail store for purchasing the articles in his/her shopping cart. This detection can be made by sensors (e.g., sensors 156 of FIG. 1) of the POS station and/or the SC device coupled to the shopping cart. In response to this detection, the SC device performs operations to track the number and/or type of articles being removed from the shopping cart and/or placed on the checkout counter, as shown by step 560. This detection can be made using beam break sensors (e.g., beam break sensors 462 of FIG. 4), image sensors (e.g., image sensors 464 of FIG. 4), barcode reader (e.g., barcode reader 490 of FIG. 4) and/or an SRC unit (e.g., SRC unit 432 of FIG. 4) of the SR device. In the barcode reader scenario, the barcode reader reads barcodes (e.g., barcodes 116_{A}, . . . , 116_{N} of FIG. 1) affixed to the articles (e.g., articles 114_{A}, . . . , 114_{N} of FIG. 1). In the SRC scenarios, the SRC unit communicates with SRC devices (e.g., SRC devices 118_{A}, . . . , 118_{N} of FIG. 1) coupled to the articles. Information specifying the tracked number and/or type of articles is then communicated from the SC device to the SIS, as shown by step 562. Notably, once the customer removes at least one article from the shopping cart, the customer is no longer eligible to be moved to a new unoccupied checkout lane.

Also in step 564, a detection can be made as to when the checkout process for this customer is complete. In response to such a detection, a message can be automatically output from the MCD (e.g., a message relaying thanks for shopping at the retail store). Alternatively or additionally, the retail software application running on the customer's MCD can be closed automatically. In a next step 568, method 500 ends or other steps are performed.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for managing checkout line efficiency of a retail store, comprising:
electronically obtaining, by a Store Intelligence System (“SIS”), first data indicating an efficiency of each checkout lane of a plurality of checkout lanes;
electronically obtaining, by the SIS, second data indicating a total number of shopping carts in each checkout lane of the plurality of checkout lanes and a total number of articles within each of the shopping carts;
generating, by the SIS, a checkout lane recommendation for the customer based on the first data and the second data; and
communicating the checkout lane recommendation from the SIS to a mobile communication device in the possession of the customer.

2. The method according to claim 1, wherein the first data specifies at least one of a start time of a checkout process, a number of articles scanned by a point of sale station during the checkout process, a rate of scanning by a cashier, a number of articles that still need to be scanned for a particular customer, and an end time of the checkout process.

3. The method according to claim 1, wherein the checkout lane recommendation comprises information specifying an estimate time of checkout for at least one of the plurality of checkout lanes.

4. The method according to claim 1, further comprising obtaining third data by the SIS indicating a change in position of the shopping cart relative to positions of other shopping carts within a respective checkout lane.

5. The method according to claim 4, further comprising updating the checkout lane recommendation based on the third data.

6. The method according to claim 1, further comprising communicating information from the SIS to a mobile communication device possessed by a store employee indicating the presence of the customer within the retail store.

7. The method according to claim 1, further comprising communicating information from the SIS to the mobile communication device specifying at least one of a welcome greeting, a customer benefit, a promotional material, an opening of a new checkout lane, a total number of articles in a respective shopping cart, an eligibility to use an express checkout lane, an eligibility to use a preferred customer checkout lane, and an issue which will likely slow down a checkout time.

8. The method according to claim 1, further comprising determining by the SIS an estimate time at which the customer will arrive at a checkout lane based on third data indicating a number of isles to/from which a respective shopping cart has traveled.

9. The method according to claim 8, wherein the checkout lane recommendation is further generated based on the third data.

10. The method according to claim 1, further comprising automatically notifying the customer via the mobile communication device that a new checkout lane has just been opened or is about to be opened if the customer has been waiting longer than other customers to checkout.

11. A system, comprising:
a Store Intelligence System (“SIS”) that:
electronically obtains first data indicating an efficiency of each checkout lane of a plurality of checkout lanes;
electronically obtains second data indicating a total number of shopping carts in each checkout lane of the plurality of checkout lanes and a total number of articles within each of the shopping carts;
generates a checkout lane recommendation for the customer based on the first data and the second data; and
communicates the checkout lane recommendation to a mobile communication device in the possession of the customer.

12. The system according to claim 11, wherein the first data specifies at least one of a start time of a checkout process, a number of articles scanned by a point of sale station during the checkout process, a rate of scanning by a cashier, a number of articles that still need to be scanned for a particular customer, and an end time of the checkout process.

13. The system according to claim 11, wherein the checkout lane recommendation comprises information specifying an estimate time of checkout for at least one of the plurality of checkout lanes.

14. The system according to claim 11, wherein the SIS obtains third data indicating a change in position of the shopping cart relative to positions of other shopping carts within a respective checkout lane.

15. The system according to claim 14, wherein the checkout lane recommendation is updated based on the third data.

16. The system according to claim 11, wherein the SIS communicates information to a mobile communication device possessed by a store employee indicating the presence of the customer within the retail store.

17. The system according to claim 11, wherein the SIS communicates information to the mobile communication device specifying at least one of a welcome greeting, a customer benefit, a promotional material, an opening of a new checkout lane, a total number of articles in a respective shopping cart, an eligibility to use an express checkout lane, an eligibility to use a preferred customer checkout lane, and an issue which will likely slow down a checkout time.

18. The system according to claim 11, wherein the SIS determines an estimate time at which the customer will arrive at a checkout lane based on third data indicating a number of isles to/from which a respective shopping cart has traveled.

19. The system according to claim 18, wherein the checkout lane recommendation is further generated based on the third data.

20. The system according to claim 11, wherein the customer is automatically notified by the SIS via the mobile communication device that a new checkout lane has just been opened or is about to be opened if the customer has been waiting longer than other customers to checkout.
